(19) United States
(12) Patent Application Publication
(10) Pub. No.: US 2025/0083374 A1
(43) Pub. Date: Mar. 13, 2025

(54) Vacuum Forming Methods for Making Printed Images with Three-Dimensional Features

(71) Applicant: Antobotics, LLC, Santa Monica, CA (US)

(72) Inventor: Hank B. Ridless, Santa Monica, CA (US)

(73) Assignee: Antobotics, LLC, Santa Monica, CA (US)

(21) Appl. No.: 18/230,443

(22) PCT Filed: Feb. 4, 2022
(86) PCT No.: PCT/US2022/015377

§ 371 Date: Aug. 4, 2023

Related U.S. Application Data
(60) Provisional application No. 63/146,550, filed on Feb. 5, 2021.
(60) Provisional application No. 63/152,790, filed on Feb. 23, 2021.

(51) Int. Cl. B29C 51/10; B29C 51/14; B29C 51/36; B29K 27/06; B29L 31/00

(52) U.S. Cl. CPC B29C 51/10; B29C 51/14; B29C 51/365; B29K 2027/06; B29K 2905/02; B29K 2911/14; B29K 2913/00; B29K 2995/0097; B29L 2031/722

(57) ABSTRACT

A vacuuming forming method for creating an embellished reproduction of an image. The image is printed on to a thermoformable substrate to create a printed substrate. A chemical compound is applied to a surface of a perforated sheet to form artistic embellishments on the surface and create an embellished sheet. The printed substrate is positioned over the embellished sheet placed on a vacuum table. Heat is applied to the printed substrate and sufficient vacuum is provided to the vacuum table to press the printed substrate on to the embellished sheet to form an embellished reproduction of the image from the printed substrate. The perforated sheet can have a three-dimensional surface, which can be included in the embellished reproduction.

### CROSS REFERENCE TO RELATED APPLICATION

This application claims priority International Application No. PCT/US2022/15377filed Feb. 4, 2022, which claims priority to U.S. provisional patent application Ser. No. 63/146,550 filed Feb. 5, 2021 and U.S. provisional patent application Ser. No. 63/152,790 filed Feb. 23, 2021, the entire content of each of which is incorporated herein by this reference.

### FIELD OF THE INVENTION

The present invention relates to methods for reproducing images, and more particularly to methods for reproducing printed images.

### BACKGROUND OF THE INVENTION

Embellished artwork can refer to printed graphic images onto which three dimensional elements are then added to the surface. Most commonly, embellished artwork refers to printed copies of original artworks onto the surface of which paint or other elements are applied. Embellished artwork can provide an impression to the consumer of a “real and unique piece of art” as opposed to a simple printed reproduction. Nonetheless, an embellished artwork is typically much less expensive than a true original piece of art. Embellished artwork in graphic displays represents a large percentage of the products sold in the global mass-market home-furnishing wall decoration category of business.

Paintings and photographs are created on a wide range of substrates that provide varied aesthetic options to the creator and purchaser of these products. An artist cotton-canvas material, for example, is a very commonly used substrate for such products. Other common substrates include linen textile, burlap textile, genuine wood and various metal plates with different textures. These various textured photographic and painted graphic displays provide an impression to the consumer of an “original and unique piece of art” as opposed to a creation produced on a smooth substrate. Nonetheless, a textured substrate with photographic or another artistic image imposed is typically significantly more expensive than such an article created with a smooth, non-textured substrate. Moreover, many desirable textured materials cannot be readily used as substrates for photographic or artistic images as they cannot be processed as required through various manufacturing and/or printing operations. For example, many heavily textured materials will not process properly through a printing process. The more heavily textured the substrate, the more problems are typically created if that substrate is processed through printing machines.

Original paintings and other three-dimensional surface detailed graphic images and displays are often attractive to consumers because they are “hand-made and unique creations” as opposed to simply printed reproductions. Nonetheless, such original creations are typically too expensive to meet the selling price requirements of the mass-market home decor wall-art and other similar low-cost-dependent markets.

Typically, vacuum forming molds are made from non-air-permeable materials, for example aluminum, in which holes are then drilled for allowing use in a vacuum forming process. It is not typically possible in the vacuum forming process to impart extremely detailed surface texture from a mold to the surface of a thermoformed substrate because there is not sufficient airflow through the mold to evacuate all the air that will otherwise be trapped between the mold and the substrate during the process. Vacuum and other thermoforming processes are, therefore, typically used to create relatively large three-dimensionally shaped products, for example a salad bowl.

### BRIEF DESCRIPTION OF THE DRAWINGS

The drawings herein are all schematic and not drawn to scale. The drawings are for illustration purposes only and are not intended to limit the scope of the present disclosure.

FIG. 1 is an isometric view of an embodiment of a perforated or air permeable layer for use in vacuum-forming methods of the invention for making printed images with three-dimensional features.

FIG. 2 is an isometric view of another embodiment of a perforated or air permeable layer for use in vacuum-forming methods of the invention for making printed images with three-dimensional features.

FIG. 3 illustrates a step of forming three-dimensional features on a perforated or air permeable layer to create a layer with three-dimensional surface features.

FIG. 4 is an isometric view of a perforated or air permeable support layer for use in vacuum-forming methods of the invention for making printed images with three-dimensional features.

FIG. 5 is an isometric view of a layer with three-dimensional surface features of the invention disposed on a perforated or air permeable support layer of the invention.

FIG. 6 is an isometric view of another layer with three-dimensional surface features of the invention.

FIG. 7 is an isometric view of a further embodiment of a perforated or air permeable layer for use in vacuum-forming methods of the invention for making printed images with three-dimensional features.

FIG. 8 is an isometric view of a thermoformable substrate of the invention with an image printed on a surface thereof.

FIG. 9 is an isometric view of a suitable vacuuming forming assembly for use in the methods of the invention.

FIG. 10 is an isometric view of the layer with three-dimensional surface features on a perforated or air permeable support layer, shown in FIG. 6, disposed on the vacuum surface of the assembly of FIG. 9.

FIG. 11 is an isometric view of the thermoformable substrate with printed image, shown in FIG. 8, overlying the layer with three-dimensional surface features on a perforated for air permeable support layer disposed on the vacuum forming assembly, shown in FIG. 10.

FIG. 12 illustrates the step of applying heat to the thermoformable substrate with printed image, shown in FIG. 11.

FIG. 13 is an isometric view of the thermoformable substrate with printed image having the three-dimensional surface features of the layer formed therein following the step of FIG. 12.

FIG. 14 is an isometric view of the thermoformable substrate with printed image, shown in FIG. 13, suitably shaped and cut for mounting on a suitable support structure of an image display.

FIG. 15 is an isometric view of the thermoformable substrate with printed image of FIG. 14 mounted on a suitable support structure of an image display.

FIG. 16 is an isometric view of the thermoformable substrate with printed image having the three-dimensional surface features of the layer formed therein, for example of FIG. 13, mounted on another suitable support structure of an image display.

FIG. 17 is an isometric view of the air permeable layer of FIG. 2 overlying a perforated or air permeable support layer of the invention, for example the perforated or air permeable support layer of FIG. 4.

FIG. 18 is an isometric view of a thermoformable substrate of the invention with an image printed on a surface thereof.

FIG. 19 is an isometric view of the air permeable layer overlying the perforated or air permeable support layer, shown in FIG. 17, disposed on the vacuum surface of a vacuum- forming assembly, for example the assembly of FIG. 9.

FIG. 20 is an isometric of the thermoformable substrate with printed image, shown in FIG. 18, overlying the air permeable layer on the perforated for air permeable support layer disposed on the vacuum forming assembly, shown in FIG. 19.

FIG. 21 illustrates the step of applying heat to the thermoformable substrate with printed image, shown in FIG. 20.

FIG. 22 is an isometric view of the thermoformable substrate with printed image having the texture of the air permeable layer formed therein following the step of FIG. 21.

FIG. 23 is an isometric view of the thermoformable substrate with printed image having the texture of the air permeable layer formed therein of FIG. 22.

FIG. 24 is an isometric view of an original article with a surface having three-dimensional surface features.

FIG. 25 is an isometric view of another original article with a surface having three-dimensional surface features.

FIG. 26 is an isometric view of a suitable molding frame position over the original article with three-dimensional surface features of FIG. 24.

FIG. 27 illustrates the step of pouring a flowable compound into the molding frame of FIG. 26 to form a mold of an air permeable material.

FIG. 28 is an isometric view of the flowable compound disposed in the molding frame of FIG. 26.

FIG. 29 is an isometric view of a suitable compression plate overlying the flowable compound of FIG. 28.

FIG. 30 illustrates the step of applying pressure to the compression plate and applying heat to the flowable compound to cure the flowable compound and form a mold of an air permeable material.

FIG. 31 is an isometric view of a mold of an air permeable material, for example of FIG. 30, with a mold surface, for example a negative mold surface corresponding to the surface with three-dimensional features of the original article of FIG. 24.

FIG. 32 is an isometric view, similar to FIG. 8, of a thermoformable substrate of the invention with an image printed on a surface thereof.

FIG. 33 is an isometric view, similar to FIG. 10, of the mold of an air permeable material of FIG. 31 disposed on the vacuum surface of a vacuum-forming assembly, for example the assembly of FIG. 9.

FIG. 34 is an isometric view of the thermoformable substrate with printed image, shown in FIG. 32, overlying the negative mold surface of the mold of an air permeable material disposed on the vacuum surface of the assembly of FIG. 33.

FIG. 35 illustrates the step of applying heat to the thermoformable substrate with printed image, shown in FIG. 34.

FIG. 36 is an isometric view of the reverse side of thermoformable substrate with printed image having the three-dimensional surface features of the air permeable mold formed therein following the step of FIG. 35.

FIG. 37 is an isometric view of the thermoformable substrate of FIG. 36, including as reversed to illustrate the three-dimensional surface features of the air permeable mold formed in the image printed on a surface thereof.

### DETAILED DESCRIPTION OF THE INVENTION

The present disclosure relates to a method for making an image on a substrate for display, an image substrate with the image thereon formed from such method and an image having the image substrate mounted thereon. The image substrate can optionally include any material onto which an image may be printed. The image substrate can optionally include any material onto which an image may be digitally printed. The image substrate can optionally include any suitable flexible material, bendable material, formable material or any combination of the foregoing. The image substrate can optionally include a thermoformable or thermoplastic substrate The image substrate can optionally be vacuum formed from a thermoformable or thermoplastic substrate. The image substrate can optionally be vacuum formed with three-dimensional embellishments, structures, features, texture or combinations of the foregoing, for example formed in a thermoformable or thermoplastic substrate.

The image display can be of any suitable type, and can optionally include a support structure of any suitable type onto which the image substrate is mounted or secured. The image display can optionally have the appearance of an image substrate mounted on a wooden stretcher bar frame. The support structure can optionally have a size and shape resembling a wooden stretcher bar frame. The support structure can optionally be a wooden stretcher bar frame. The support structure can optionally be any of the types disclosed in U.S. Pat. No. 8,959,812, the entire content of which is incorporated herein by this reference. The support structure can optionally be any of the types disclosed in International Application No. PCT/US21/43803, the entire content of which is incorporated herein by this reference.

The image can be provided on at least the central portion of the outer surface of the image substrate. The image can optionally, and additionally, be provided on one or more of the peripheral portions of the image substrate. The image can be provided or formed in any suitable manner on the image substrate. including by printing. digitally printing. painting. screening. molding or any combination of the foregoing.

The support structure can be formed from any suitable material. including paper. cardboard. paperboard. corrugated board. fiberboard. wood. metal. plastic. foam or any combination of the foregoing. The support structure can be a unitary structure. for example made from a single piece or block of material, or formed from a plurality of parts. As used herein. the term corrugated board means a material. for example a paperboard. having permanent corrugations or flutes. Such a corrugated sheet can optionally have an adherent board. which can be called a liner board and for example can be made of paperboard. on one or both sides. The corrugated portion or fluted layer or portion of corrugated board can optionally be referred to as the medium of the board. Suitable corrugated board can include single wall board. single face board and double wall board. Suitable single face board and suitable single wall board can each include F flutes. E flutes. B flutes. C flutes or any other suitable flute configuration. Suitable double wall board can include F/E flutes. E/B flutes. E/C flutes. B/C flutes or any other suitable flute configuration. Corrugated board used in the support structure of the invention. including any part thereof. can optionally include single wall board of F or E flute or any specialty flute that is thinner than F or E flute. The paper in a suitable corrugated board used in the support structure of the invention can be of any suitable weight. Corrugated board used in the support structure of the invention, including any part thereof. can optionally include single wall board having front and back liner boards and a fluted layer therebetween made from paper or board. each of the three layers having paper weights between 15 and 42 pounds per thousand square feet. Corrugated board used in the support structure of the invention. including any part thereof. can optionally include single wall board having front and back liner boards of 32 pounds per thousand square feet and a fluted layer therebetween made from paper or board of 23 pounds per thousand square feet. Corrugated board used in the support structure of the invention. including any part thereof. can optionally include single wall board having front and back liner boards of 42 pounds per thousand square feet and a fluted layer therebetween made from paper or board of 40 pounds per thousand square feet. Where the support structure is partially or entirely formed from corrugated board. the corrugated board can optionally be creased. perforated. slotted. slit. skived or otherwise weakened along any or all fold lines to facilitate folding of elements of the support structure along a fold line.

An optional vacuuming forming method of the invention can create embellished reproductions of an image, an image with three-dimensional texture or both. The method can optionally include the step of printing the image on to a thermoformable or thermoplastic substrate to create a printed substrate. The method can optionally include the step of providing a perforated sheet having a surface. The method can optionally include the step of applying a chemical compound to the surface of the sheet to form artistic embellishments on the surface and create an embellished sheet. The artistic embellishments can optionally be three-dimension artistic embellishments. The artistic embellishments can optionally have relatively small height differentials between peaks and troughs, for example not greater than 0.25 inch. The method can optionally include the step of positioning the embellished sheet on a vacuum table. The method can optionally include the step of positioning the printed substrate over the embellished sheet. The method can optionally include placing the printed substrate, or laying the printed substrate, directly on the embellished sheet. The method can optionally include the step of heating the printed substrate. The method can optionally include the step of providing sufficient vacuum to the vacuum table to press or draw the printed substrate on to the embellished sheet to form an embellished reproduction of the image from the printed substrate. The method can optionally include the step of removing the embellished reproduction from the embellished sheet. The method can provide embellished reproductions of artwork, such as an image.

The perforated sheet of the method can optionally have a surface with a texture. The perforated sheet of the method can optionally be an air permeable textile. The air permeable textile can optionally have a surface with a texture. The texture can be of any suitable type, for example a texture of a woven textile, a knit textile, a crocheted textile, a nonwoven textile, felt, wool, silk, acrylic, cotton, polyester, rayon, nylon, leather, canvas, artist's canvas, wood, metal plates, plastic or any combination of the foregoing. The air permeable textile can optionally be a flexible material made by creating an interlocking bundle of fibers, yarns or threads, a material made from man-made or natural fibers, a woven textile, a knit textile, a crocheted textile, a nonwoven textile, felt, wool, silk, acrylic, cotton, polyester, rayon, nylon, leather, canvas, artist's canvas or any combination of the foregoing. The surface of the air permeable layer can optionally have relatively small height differentials between peaks and troughs, for example not greater than 0.25 inch. The air permeable layer can optionally have a smooth surface.

The perforated sheet of the method can optionally be a sheet of perforated aluminum or wood. The applying step of the method can optionally include painting with any suitable tool, including for example a brush, a pallet knife, squeeze bottle, any tool that can apply paint, any tool that can apply a chemical, a combination of the foregoing or any other tool or method. The chemical compound of the method can optionally be a paint, an acrylic paint, a silicone paint, an acrylic polymer, a silicone, a moldable material, a curable compound, a heat-curable compound or any combination of the foregoing. The substrate of the method can optionally be made from polypropylene (PP), polystyrene, polyvinyl chloride (PVC), a rigid PVC or any suitable thermoformable or thermoplastic material. The substrate of the invention can optionally be referred to as a thermoformable substrate or a thermoplastic substrate. The substrate of the method can have any suitable thickness, for example a thickness of 0.003 inch or a thickness ranging from 0.002 to 0.020 inch. The step of positioning the printed substrate over the embellished sheeting of the method, or laying the printed substrate directly on the embellished sheet, can optionally include positioning the printed substrate over the embellished sheet with the image of the printed substrate facing away from the embellished sheet. The art embellishments can optionally be three-dimensional art embellishments. The printing step of the method can be of any suitable type, for example digital printing, digital inkjet printing, offset printing, flexographic printing or any combination of the foregoing. An embellished reproduction of an image can include reproductions of the artistic embellishments. When the perforated sheet has a surface with a texture or three-dimensional features, the embellished reproduction can include a reproduction of such texture or three-dimensional features.

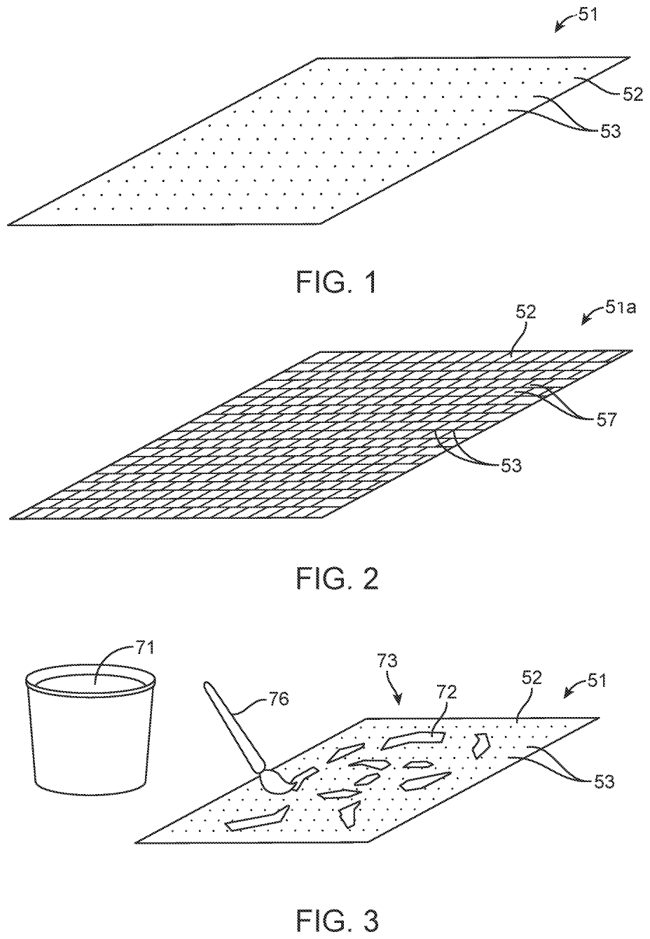

An optional embodiment of the method of the invention for providing embellished reproductions of artwork is as follows, and shown for example in FIGS. 1-16. Any suitable perforated sheet 51 can be utilized in the method. Perforated sheet 51 can be of any suitable size and shape, for example a size and shape corresponding to the desired embellished reproduction. A generic perforated sheet 51 having at least one surface 52 provided with a plurality of holes 53 extending through the sheet 51 is shown in FIG. 1. As used in this document, holes can include perforations, spaces, passageways or channels. The holes, perforations, spaces, passageways or channels can optionally be arranged in a grid or pattern, for example to provide consistent air flow through the surface of the perforated sheet.

The perforated sheet 51 can optionally be a textile, for example an air permeable textile such as a very air permeable textile. Sample textiles can optionally include a flexible material made by creating an interlocking bundle of fibers, yarns or threads, a material made from man-made or natural fibers, a woven textile, a knit textile, a crocheted textile, a nonwoven textile, felt, wool, silk, acrylic, cotton, polyester, rayon, nylon, leather, canvas, artist's canvas or any combination of the foregoing. The air permeable nature of certain textiles can provide the plurality of holes, perforations, spaces, passageways or channels 53 in sheet 51, for example a plurality of holes, perforations, spaces, passageways or channels 53 arranged in a grid or pattern corresponding to the spaces or passageways between the fibers of the textile.

Sheet 51 can optionally be provided with a texture 54, for example at least one surface 52 can be provided with the texture 54. The texture can be of any suitable type, for example a texture 54 desired in the background of the embellished artwork or reproduction 56. Sample textures 54 can optionally include a texture of a woven textile, a knit textile, a crocheted textile, a nonwoven textile, felt, wool, silk, acrylic, cotton, polyester, rayon, nylon, leather, canvas, artist's canvas, wood, metal plates, plastic or any combination of the foregoing. Texture 54 can optionally be inherently provided by the composition of the perforated sheet 51, for example when the sheet 51 is a textile having a textured surface. A perforated sheet 5 la of leather, for example formed from interwoven leather strips 57 or formed to have an appearance of a plurality of interwoven leather strips, is shown in FIG. 2. The leather strips 57 can optionally be spaced apart to provide spaces, passageways or holes 53, for example arranged in a grid or pattern, through the surface 52 of the sheet 51a.

In an optional step, a chemical compound 71 is applied to surface 52 of the sheet 51 to form the desired artistic embellishments 72 on the surface and create an embellished sheet 73 (see FIG. 3). The artistic embellishments can optionally be applied on top of any texture 54 of the sheet 51. The artistic embellishments 72 can optionally be referred to as three-dimensional artistic embellishments. The artistic embellishments, or three-dimensional artistic embellishments, can optionally be shallow, for example have a surface with height differentials between peaks and troughs of not greater than 0.25 inch. The chemical compound 71 is optionally sufficiently strong when cured, for example dried or hardened, so that it is not deformed during use as a mold in any subsequent thermoforming step of the method. The chemical compound can be of any suitable type, for example appropriate to the application, including for example paint, acrylic paint, silicone paint, an acrylic polymer, silicone, a moldable material, a curable compound, a heat-curable compound or any combination of the foregoing. The application of the chemical compound can be in any suitable manner or any suitable means. For example, the applying step can optionally include painting or applying the chemical compound 71 with any suitable tool 75, for example a brush, a pallet knife, squeeze bottle, any tool that can apply paint, any tool that can apply a chemical, a combination of the foregoing or any other tool or method. The applying step can optionally include a range of brushstrokes, pallet knife applications, squeeze bottle applications and other application options typical of artwork, for example in the wall décor industry. The embellished sheet 73 can optionally be referred to as mold, either a positive mold or a negative mold, for example for use in a thermoforming or other step.

In an optional step, additional holes may need to be created through the embellished sheet, including for example through the artistic embellishments 72 thereon, to provide consistent or sufficient air flow through the sheet, for example to optimize the quality of thermoforming in any subsequent vacuum forming step of the method. Such additional holes may be formed in any suitable manner, for example drilling or punching.

The embellished sheet 73 with the desired three-dimensional surface relief pattern of the desired embellished artwork on the surface thereof can optionally serve as thermoforming mold, for example a male thermoforming mold.

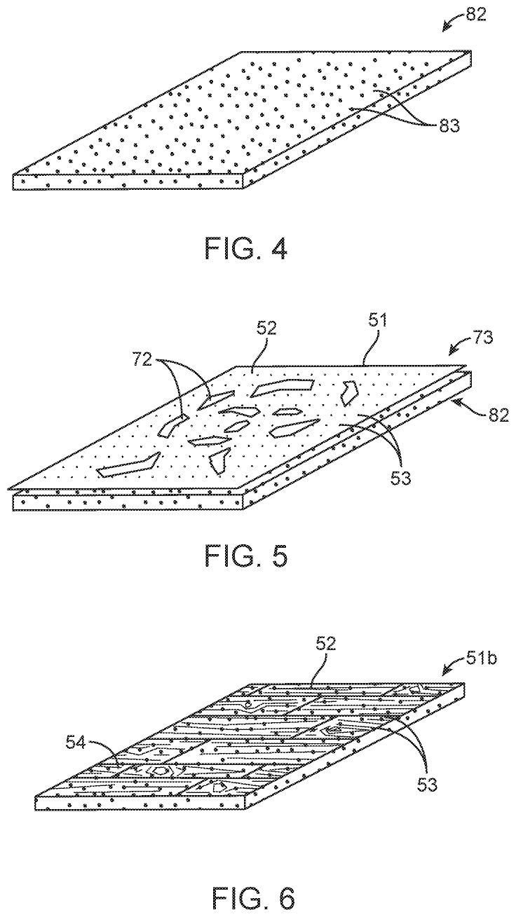

In an optional step, a porous member 82 is optionally provided to support the embellished sheet 73 during any subsequent vacuum forming step (see FIGS. 4-5). The porous member can optionally be called a porous member, a support member, a support, a porous sheet or any combination of the foregoing. The porous member 82 is provided with a plurality passageways or opening 83 extending therethrough to permit sufficient passage of air or gas through the member during any vacuum forming or thermoforming step of the method. The porous member can be of any suitable size, shape and thickness. For example, the porous member 82 optionally has a size and shape approximately equal to the size and shape of the perforated sheet 51. The porous member can be made from any suitable material, for example a lightweight material, a sponge, a sponge-like material or any combination of the foregoing.

In an optional step, the porous member 82 is disposed below the perforated sheet 51, as shown in FIG. 5. Porous member 82 can serve as a support backing to embellished sheet 73 during any subsequent vacuum forming or thermoforming step.

The perforated sheet 51 can optionally be a porous member, for example made from any suitable material discussed above for porous member 82. A perforated or porous sheet 51b is shown in FIG. 6, and is optionally made from any porous material discussed above with respect to porous member 82. Perforated sheet 51b is provided with a plurality of perforations, holes, spaces or passageways 53 extending therethrough, including through at least one surface 52 of the sheet 51b. Surface 52 can optionally be provided with any suitable texture 54, for example as discussed above. Sheet 51b is shown in FIG. 6 as having a wood texture 54 formed in surface 52. Perforated, porous sheet 51b can optionally be made with a sufficient thickness so as not to require the support of an additional backing during any subsequent vacuuming forming step. Suitable or desired art embellishments 72 can optionally be formed on surface 52 of sheet 51b in any suitable, for example as discussed above, to create an embellished sheet 73 from the perforated or porous sheet 51b.

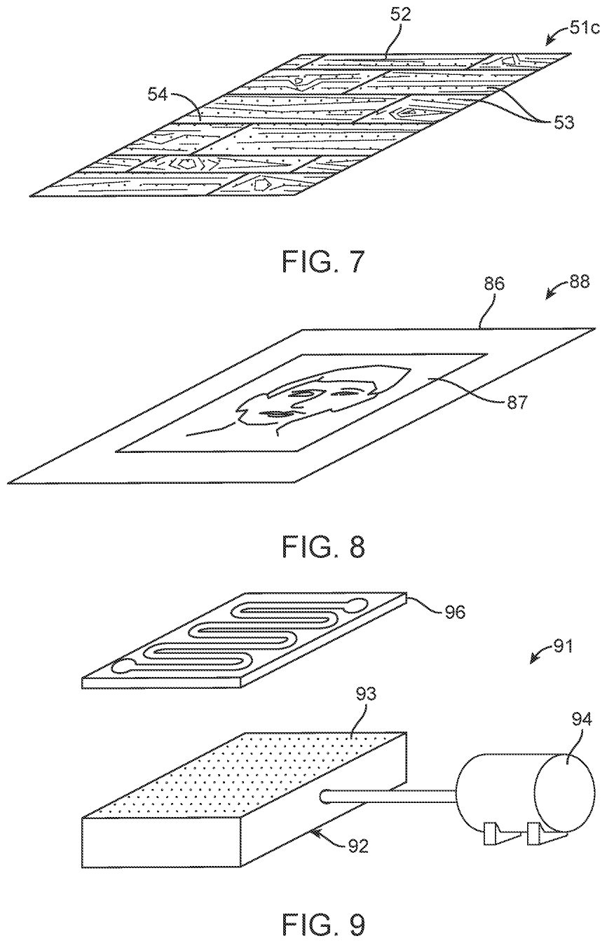

The perforated sheet 51 can optionally be a sheet of perforated aluminum, wood or any other substantially rigid material sufficiently strong to withstand the pressure of any subsequent vacuum-forming or thermoforming process. Optional rigid, perforated sheet 51c shown in FIG. 7 is a sheet or board of wood provided with a plurality of holes, perforations. spaces, passageways or channels 53 extending therethrough, including through at least one surface 52 of the sheet 51c. The holes in such a rigid, perforated sheet can be formed by any suitable means, for example drilling or punching. The plurality of holes, perforations, spaces, passageways or channels can optionally be arranged in a grid or pattern.

The holes or passageways are optionally sized and of a sufficient density to enable sufficient air pathways through the sheet 51 during any vacuuming forming or thermoforming step of the method or process. For example, the holes 53 can optionally have a diameter of ⅛ inch or smaller and a frequency of nine holes per square inch over surface 52. Perforated sheet 51c can optionally be made with a sufficient thickness so as not to require the support of an additional backing during any subsequent vacuuming forming or thermoforming step. A wood sheet 51c can have an inherent or formed wood texture 54 in surface 52, for example as serving as a background for the reproduction. Where rigid, perforated sheet 51c is made from aluminum, a desired texture 54 can optionally be inherent to the aluminum sheet or optionally formed is any suitable manner, for example engraving surface 52, and can optionally serve as a background for the reproduction. Suitable or desired art embellishments 72 can optionally be formed on surface 52 of sheet 51c in any suitable, for example as discussed above, to create an embellished sheet 73 from the wood, aluminum or rigid sheet 51c.

In an optional step, a substrate 86 of any suitable type is provided (see FIG. 8). The substrate 86 can optionally be referred to as a thermoformable substrate or a thermoplastic substrate. The substrate can optionally be made from polyester, polypropylene (PP), polystyrene, polyvinyl chloride (PVC), a rigid PVC or any suitable thermoformable or thermoplastic material. Substrate 86 can optionally be made from any thermoformable or thermoplastic material that can be printed with conventional printing methods. Optional printing methods include digital printing, digital inkjet printing, offset printing and flexographic printing. The material of substrate 86 is optionally suitable for use in a vacuum forming process. Substrate 86 can be of any suitable size, shape and thickness. For example, the substrate optionally has a size and shape at least as large as the image to be provided thereon and the support structure on which it is to be mounted. Substrate 86 is optionally a sufficiently thin film or layer such that, after the thermoforming process, the texture 54 of the mold will be clearly detailed when viewed from the printed side of the substrate 86 even if the printed side was away from the face of the mold during any vacuum forming or thermoforming step of the method. The substrate has any thickness suitable for thermoforming, for example a thickness of 0.003 inch or a thickness ranging from 0.002 to 0.020 inch.

In an optional step, an image 87 is formed on the substrate 86 in any suitable manner to form a printed substrate 88 (see FIG. 8). The image 87 can optionally be printed on substrate 86 in any suitable manner, for example any conventional printing method. Optional printing methods include digital printing, digital inkjet printing, offset printing and flexographic printing.

In an optional step, a vacuum system 91 can be provided (see FIGS. 9-13). The vacuum system can optionally be a conventional vacuum system. The vacuum system 91 can optionally include a vacuum table 92, having a vacuum surface 93, coupled to a pneumatic pump 94 of any suitable type for providing negative pressure or vacuum to surface 93

In an optional step, a heater or heating element 96 can be provided (see FIGS. 9-13). The heater 96 can be of any suitable type, for example any conventional heater or heater suitable for use with a vacuum table 92.

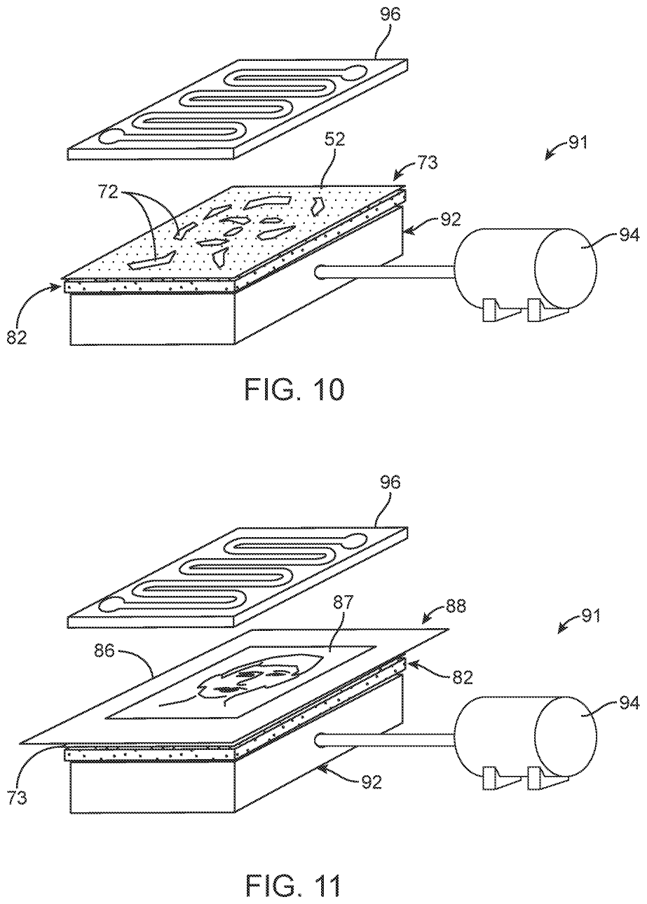

In an optional step, embellished sheet 73 is positioned on vacuum table 92, optionally overlying vacuum surface 93 of the vacuum table to that suction or negative pressure from the vacuum table can draw air through the embellished sheet or mold 73 (see FIG. 10). Surface 52 of the embellished sheet 73 is disposed upwardly or facing away from the vacuum table 92. Porous member 82 is optionally disposed between the embellished sheet 72 and surface 93 of the vacuum table 92 for providing support to the embellished sheet during the optional vacuum-forming step and the optional thermoforming step of the method.

In an optional step, printed substrate 88 is positioned over embellished sheet 73 (see FIG. 11). The printed substrate 88 is optionally aligned with the embellished sheet 73, the vacuum surface 93 or both so that the artistic embellishments 72 on the embellished sheet are desirably or properly aligned or registered with the desired locations on the printed substrate. The printed substrate 88 can optionally be placed directly on the embellished sheet 73. The printed substrate 88 can optionally be positioned close to but above the embellished sheet. Relatively small height differentials between peaks and troughs of the artistic embellishments 72 of the embellished sheet can facilitate the printed substrate being placed directly on or close to the embellished sheet 73. Image 87 provided on the printed substrate 88, and the surface of the substrate 88 on which the image is formed, can optionally face away from the embellished sheet 73 and vacuum surface 93 of the vacuum table, as shown in FIG. 11. For example, the embellished sheet 73 can serve as a positive mold. It is appreciated that image 87 provided on the printed substrate 88, and the surface of the substrate 88 on which the image is formed, can optionally face vacuum surface 93 of the vacuum table (not shown). For example, the embellished sheet 73 can be configured to serve as a negative mold.

In an optional step, the perimeter of the printed substrate 88 can be clamped to the vacuum system 91 (not shown), for example to the vacuum table 92, so that the printed substrate is held in place, for example relative to the embellished sheet 73, the vacuum table 92 or both. Such clamping can facilitate proper alignment or registration of the artistic embellishments 72 on the embellished sheet with the desired locations on the printed substrate throughout the vacuum forming process. The printed substrate 88 can optionally not be clamped to the vacuum system 91. for example when the shrinking, movement or both of the printed substrate 88 results in an acceptable finished product.

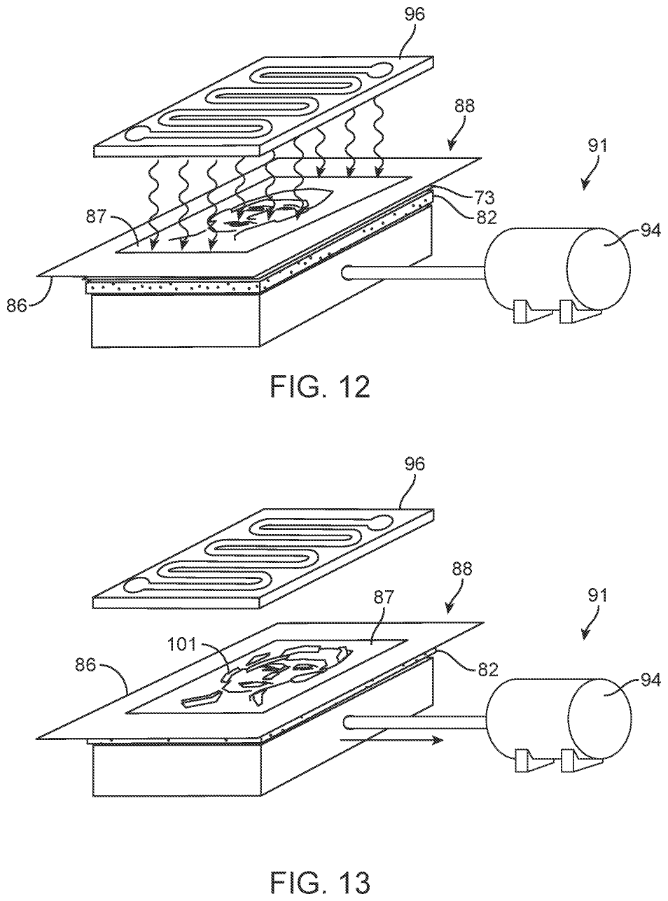

In an optional step, the printed substrate 88 is heated, for example to a desired temperature, to permit deformation of the substrate 88, for example in a thermoforming step (see FIG. 12). The printed substrate can be heated in any suitable manner, for example by a suitable heater appropriately positioned relative to the printed substrate 88. Heater 96, overlying the printed substrate and the embellished sheet 73, can optionally be used to provide heat to the printed substrate.

In an optional step, sufficient vacuum or negative pressure is provided to vacuum table 92, for example from pump 94, to press or draw printed substrate 88 on to embellished sheet 73 to cause artistic embellishments 72 on the embellished sheet to deform printed substrate, for example in a thermoforming process or step (see FIG. 13). The deformation of the printed substrate 88 by the embellished sheet 73 optionally creates reproduced embellishments 101 in the printed substrate 88, for example substantially similar to or identical to the artistic embellishments 72 provided on the embellished sheet 73. The reproduced embellishments 101 are optionally provided on image 87 of the printed substrate 88. The reproduced embellishments 101 can optionally be referred to as three-dimensional reproduced embellishments. The thermoforming step can optionally cause any texture 54 provided on the embellished sheet 73, for example provided on part of all of surfaced 52 of the perforated sheet 51, to be formed in the printed substrate 88. The reproduced embellishments 101. texture provided by texture 54 on the embellished sheet 73 or both can optionally serve to form an embellished reproduction on the printed substrate 88 of the original image selected to be printed. Relatively small height differentials between peaks and troughs of the artistic embellishments 72 on the embellished sheet can facilitate relatively small draws of the printed substrate 88 during the vacuum forming process and thus the creation of relatively fine reproduced embellishments 101.

In an optional step. the embellished production is optionally removed from the embellished sheet 73 and the vacuum table 92.

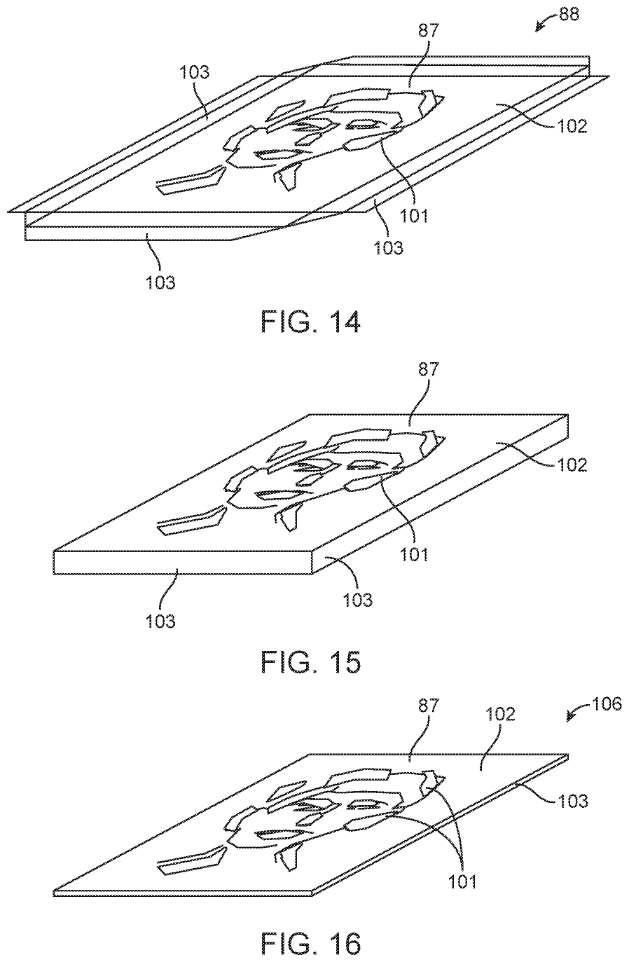

In an optional step. the printed substrate 88 is processed to permit mounting of the printed substrate. as embellished. on a desired support structure. Such processing can include cutting or trimming. for example including die cutting. Such processing can optionally provide the printed substrate 88 with a central portion 102 and an optional peripheral portion 103 (see FIG. 14). The image 87. reproduced embellishments. texture or any combination of the foregoing can be provided on the central portion 102. The image 87. reproduced embellishments. texture or any combination of the foregoing can optionally be provided on some or any part of the peripheral portion of the peripheral portion 103. Such processing can optionally provide suitable creases, slits. slots. skives or other weakened lines in the printed substrate 88. for example to permit folding of the peripheral portion 103 relative to the central portion 102 for mounting the printed substrate 88 on the support structure.

In an optional step. the embellished reproduction. for example printed substrate 88 as processed above. is mounted in any suitable manner. for example in any suitable manner to form an image display. The embellished reproduction can optionally be mounted on a support structure consisting of or resembling a wooden stretcher bar frame (see FIGS. 15-16). For example. the embellished reproduction is mounted to such a support structure by overlying central portion 102 over the front of the support structure and folding peripheral portion 103 around the support structure, as shown in FIG. 15. The central portion 102 and folded peripheral portion 103 can be secured to the support structure in any suitable manner. for example staples. tacks. adhesive or any combination of the foregoing. The mounted embellished reproduction can form an image display 106. for example as shown in FIG. 16.

The foregoing method can advantageously create embellished artwork with higher quality and more detailed results than can typically be produced with prior art methods to meet marketplace price constraints. The foregoing method advantageously speeds and simplifies the production process when compared to the typical manual labor required to add embellishments to preprinted material with prior art methods. The optional use of ultra-thin films for substrate 86 can enable the thermoformed texture, embellishments or both to be visible through the front of the printed substrate 88, and can optionally enable the printed side of the substrate 88 to be positioned away from the embellished sheet or mold 73. This can be particularly important as a typical problem of thermoforming preprinted materials is that the ink often can stick to the mold making removal of the formed substrate from the mold difficult.

An optional vacuuming forming method of the invention can produce an image with a texture or three-dimensional features. As used herein, texture can optionally be referred to as three-dimensional texture. The texture or three-dimensional features can be of any suitable type, for example any texture or features disclosed herein or any three-dimensional surface disclosed herein. The texture or three-dimensional features can optionally be a surface with any suitable surface reliefs thereon. The method can optionally include the step of printing the image on to a thermoformable substrate to create a printed substrate. The method can optionally include the step of providing an air permeable layer having texture as a mold. The method can optionally include the step of positioning the air permeable layer on a vacuum table. The method can optionally include the step of positioning the printed substrate over the air permeable layer. The method can optionally include the step of heating the printed substrate. The method can optionally include the step of providing sufficient vacuum to the vacuum table to press, or to draw, the printed substrate on to the air permeable layer to form a reproduction of the artwork from the printed substrate. The method can optionally include the step of removing the reproduction from the air permeable layer.

The air permeable layer of the method can optionally have three-dimensional surface reliefs, for example for a desired texture or surface reliefs in the finished product. The air permeable layer can optionally have a surface with relatively small height differentials between peaks and troughs, for example not greater than 0.25 inch. The air permeable layer can optionally be approximately flat. The printing step of the method can be of any suitable type, for example digital printing, digital inkjet printing, offset printing. flexographic printing or any combination of the foregoing. The thermoformable substrate of the method can have any suitable thickness, for example a thickness of 0.003 inch or a thickness ranging from 0.002 to 0.020 inch. The air permeable material can optionally be a textile. The step of positioning the printed substrate over the air permeable layer of the method can optionally include positioning the printed substrate over the air permeable with the image of the printed substrate facing away from the air permeable layer. The step of positioning the printed substrate over the air permeable layer of the method can optionally include positioning the printed substrate over the air permeable with the image of the printed substrate facing the air permeable layer.

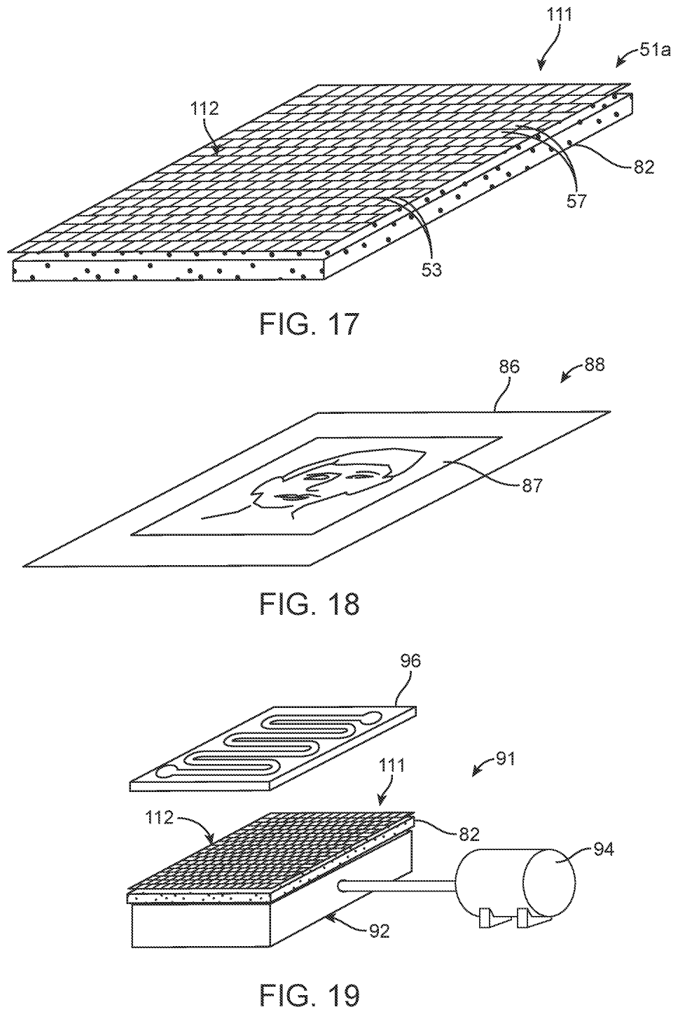

An optional embodiment of the method for producing an image, optionally with a texture, is as follows and shown for example in FIGS. 17-23. In an optional step, an air permeable layer 111 of any suitable type is provided for use as a mold, for example in a thermoforming step or process (shown generically in FIG. 17). The air permeable layer optionally requires no holes be drilled therein for permitting the layer to be used as mold. The air permeable layer can optionally be a textile, for example an air permeable textile such as a very air permeable textile. Sample textiles can optionally include a flexible material made by creating an interlocking bundle of fibers, yarns or threads, a material made from man-made or natural fibers, a woven textile, a knit textile, a crocheted textile, a nonwoven textile, felt, wool, silk, acrylic, cotton, polyester, rayon, nylon, leather, canvas, artist's canvas or any combination of the foregoing. The air permeable nature of certain textiles can provide a plurality of perforations or holes, which can optionally be referred to as passageways, spaces or channels, in the textile enabling the textile suitable for use in a vacuum forming step or process.

The air permeable layer 111 can optionally be provided with a texture, for example at least one surface of the mold can be provided with a texture. The air permeable layer or mold 111 can optionally have three-dimensional surface reliefs 112 on the at least one surface, for example to form a texture. The air permeable layer or mold can optionally be provided with a surface, which can be called a three-dimensional surface, with relatively small height differentials between peaks and troughs in the surface, for example not greater than 0.25 inch. The three-dimensional surface of the air permeable layer or mold can optionally be described as approximately flat. The three-dimensional surface can optionally be a textured surface, that is a surface with texture or a three-dimensional texture. The texture of the air permeable layer or mold 111 can be of any suitable type, for example a texture desired in the background of a reproduction of an image or other art piece. Sample textures can optionally include a texture of a woven textile, a knit textile, a crocheted textile, a nonwoven textile, felt, wool, silk, acrylic, cotton, polyester, rayon, nylon, leather, canvas, artist's canvas, wood, metal plates or any combination of the foregoing. The texture can optionally be inherently provided by the composition of the air permeable layer 111, for example when the mold is a textile having a textured surface. Perforated sheet 51a of leather, shown in FIG. 2, can be a suitable mold and can optionally be referred to as an air permeable layer 111, for example air permeable layer or mold. As discussed above, leather sheet 51a can optionally be formed from a plurality of interwoven leather strips 57, or can optionally be formed to have an appearance of a plurality of interwoven leather strips. The interwoven leather strips can provide three-dimensional surface reliefs in the surface 52 of the leather sheet 51a. The leather strips 57 can optionally be spaced apart to provide channels or passageway 53, for example arranged in a grid or pattern, through the surface 52 of the sheet 51a. Air permeable layer or mold 111 having a textured surface can optionally serve as thermoforming mold, for example a male thermoforming mold. The air permeable layer can optionally be provided with a smooth surface, for example without three-dimensional features.

In an optional step, a porous member of any suitable type, for example porous member 82 discussed above, can be provided (see FIG. 4). In an optional step, the porous member 82 is disposed below the air permeable layer 111, as shown in FIG. 17. Porous member 82 can serve as a support backing to air permeable layer 111 during any subsequent vacuum forming or thermoforming step.

In an optional step, a substrate of any suitable type, for example substrate 86 discussed above, can be provided (see FIG. 18). In an optional step, an image 87 is formed on the substrate 86 in any suitable manner to form a printed substrate 88, for example as discussed above.

In an optional step, any suitable vacuum system, for example vacuum system 91 discussed above, can be provided (see FIGS. 19-22). The vacuum system 91 can optionally include a vacuum table 92, having a vacuum surface 93, coupled to a pneumatic pump 94 of any suitable type for providing negative pressure or vacuum to surface 93. In an optional step, any suitable heater or heating element, for example heater or heating element 96 discussed above, can be provided (see FIGS. 19-22). The heater 96 can be of any suitable type, for example any conventional heater or heater suitable for use with a vacuum table 92.

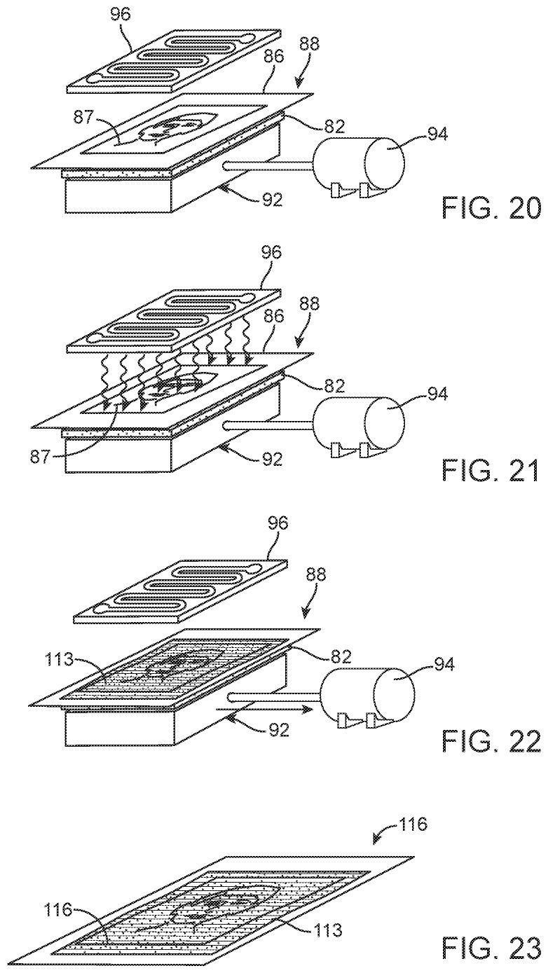

In an optional step, the air permeable layer or mold 111 is positioned on vacuum table 92, optionally overlying vacuum surface 93 of vacuum table 92, so that suction or negative pressure from the vacuum table can draw air through the mold (see FIG. 20). The surface 52 of the air permeable layer 111, for example with three-dimensional surface reliefs 112 thereon, is disposed upwardly or away from the vacuum table 92. Porous member 82 is optionally disposed between the air permeable layer 111 and vacuum surface 93 of the vacuum table 92.

In an optional step, printed substrate 88 is positioned over air permeable layer or mold 111 (see FIG. 20). The printed substrate 88 is optionally aligned with the air permeable layer 111, the vacuum surface 93 or both so that the air permeable layer 111, including three-dimensional surface reliefs 112, is desirably or properly aligned or registered with the desired locations on the printed substrate. The printed substrate 88 can optionally be placed directly on the air permeable layer 111. The printed substrate 88 can optionally be positioned close to but above the mold. Relatively small height differentials between peaks and troughs of the three-dimensional surface reliefs 112 of the air permeable layer can facilitate the printed substrate 88 being placed directly on or close to the air permeable layer 111. Image 87 provided on the printed substrate 88, and the surface of the substrate 88 on which the image is formed, can optionally face away from the air permeable layer 111 and vacuum surface 93 of the vacuum table, as shown in FIG. 20. For example, the air permeable layer 111 can serve as a positive mold. It is appreciated that image 87 provided on the printed substrate 88, and the surface of the substrate 88 on which the image is formed, can optionally face the air permeable layer 111 and vacuum surface 93 of the vacuum table (not shown). For example, the air permeable 111 can be configured to serve as a negative mold.

In an optional step, the perimeter of the printed substrate 88 can be clamped to the vacuum system 91 (not shown), for example to the vacuum table 92, so that the printed substrate is held in place, for example relative to the air permeable layer 111, the vacuum table 92 or both. The printed substrate 88 can optionally not be clamped to the vacuum system 91, for example when the shrinking. movement or both of the printed substrate 88 results in an acceptable finished product.

In an optional step, the printed substrate 88 is heated, for example to a desired temperature, to permit deformation of the substrate 88, for example in a thermoforming step (see FIG. 21). The printed substrate can be heated in any suitable manner, for example by a suitable heater appropriately positioned relative to the printed substrate 88. Heater 96, overlying the printed substrate and the embellished sheet 73, can optionally be used to provide heat to the printed substrate 88.

In an optional step, sufficient vacuum or negative pressure is provided to vacuum table 92, for example from pump 94, to draw or press printed substrate 88 on to air permeable layer 111 to cause the three-dimensional surface reliefs 112 of the mold to deform the printed substrate, for example in a thermoforming process or step (see FIG. 22). The deformation of the printed substrate 88 by the air permeable layer 111 optionally reproduces the three-dimensional surface reliefs 112 on surface 52 of the air permeable layer 111 on to the printed substrate 88, for example into the image 87 formed on the printed substrate 88. The three-dimensional surface reproduced on the printed substrate, including on image 87 of the substrate 88, can be referred to as a reproduced three-dimensional surface 113 (see FIG. 22). Relatively small height differentials between peaks and troughs of the three-dimensional surface reliefs 112 of the air permeable layer can facilitate relatively small draws of the printed substrate 88 during the vacuum forming process and thus the creation of relatively fine reproduced surface reliefs. The method can provide an image with the reproduced three-dimensional surface 113, which can optionally be a reproduced three-dimensional texture.

In an optional step, the printed substrate 88 with the reproduced three-dimensional surface 113, which can optionally be referred to as a printed image with texture 116, is optionally removed from the air permeable layer 111 and the vacuum table 92. In an optional step, the printed image 116 can be mounted on any desirable support structure to provide an image display (not shown).

The foregoing method can advantageously create textured photographs and other artwork or images of high quality and detailed result. The method can be used to print onto thermoformable substrates, which can optionally have a smooth surface, that are then processed through a thermoforming process. The foregoing method can advantageously use highly air permeable original materials as molds in order to transfer detailed surface details of those materials into a substantially flat thermoformed substrate. The molds can optionally be almost flat in their surface plane, for example having height differentials of no more than 0.25″ from peak to trough. The thermoformed substrate material can, after the thermoforming process, also remain essentially flat, for example with height differentials in its surface plane of no more than 0.25″ from peak to trough.

The optional use of ultra-thin films for substrate 86 can enable the thermoformed texture to be visible through the front of the printed substrate 88, for example in the case of a positive mold, and can optionally enable the printed side of the substrate 88 to be positioned away from the air permeable layer 111. This can be particularly important where air permeable layer 111 is a negative mold as a typical problem of thermoforming preprinted materials is that the ink often can stick to the mold making removal of the formed substrate from the mold difficult.

An optional vacuuming forming method for creating an image with a three-dimensional surface is provided. The created image can optionally be a reproduction of an image having the three-dimensional surface, for example an original painting. The created image can optionally be a copy of a photograph on any suitable or desirable three-dimensional artistic surface. The artistic surface can optionally be any surface having artistic embellishments or other three-dimensional features. The artistic surface can optionally resemble any three-dimensional surface, or example a texture, a wood surface, a textile surface, a leather surface, a woven or nonwoven surface, a metal surface, a plastic surface or any combination of the foregoing.

The method can optionally include the step of printing the image on to a thermoformable substrate to create a printed substrate. The method can optionally include the step of providing a mold formed from an air permeable material and having a three-dimensional mold surface. The method can optionally include the step of positioning the mold on a vacuum table. The method can optionally include the step of positioning the printed substrate over the mold. The method can optionally include the step of heating the printed substrate. The method can optionally include the step of providing sufficient vacuum to the vacuum table to press or draw the printed substrate on to the three-dimensional mold surface of the mold to form a reproduction of the artwork with the three-dimensional surface from the printed substrate. The method can optionally include the step of removing the reproduction from the mold.

The providing step of the method can optionally include forming the mold from a flowable mixture or compound of granular particles and a binder that when cured or hardened forms an air permeable solid from the mixture. The binder optionally serves to bind, secure or adhere the granular particles together in a manner that results in flow passageways between the adjoined particles. For example, the binder optionally does not bind or adhere to all surfaces of a particle but instead only to some or a portion of the surfaces of a particle. The binder optionally coats the particles when the mixture or compound is in a flowable state, that is before it is cured or hardened. When cured or hardened, the coating optionally softens, coalesces and binds the granular particles at only select locations to form an air permeable solid. The granular particles can optionally be sand. The binder or epoxy can optionally be a powder, a liquid or both. The mixture can optionally include a catalyst. The providing step of the invention can optionally include engraving the three-dimensional mold surface into a solid formed from the air permeable material. The mold can optionally be a positive mold, a negative mold or a combination of both. The three-dimensional surface can optionally have a texture. The texture can be of any suitable type, for example a texture of a woven textile, a knit textile, a crocheted textile, a nonwoven textile, felt, wool, silk, acrylic, cotton, polyester, rayon, nylon, leather, canvas, artist's canvas, wood, metal plates, plastic or any combination of the foregoing. The three-dimensional surface can optionally include a brushed surface. The thermoformable substrate of the method can have any suitable thickness, for example a thickness of 0.003 inch or a thickness ranging from 0.002 to 0.020 inch. The step of positioning the printed substrate over the mold of the invention can optionally include positioning the printed substrate over the mold with the image of the printed substrate facing away from the mold. The step of positioning the printed substrate over the mold of the invention can optionally include positioning the printed substrate over the mold with the image of the printed substrate facing the mold. The printing step of the method can be of any suitable type, for example digital printing, digital inkjet printing, offset printing, flexographic printing or any combination of the foregoing.

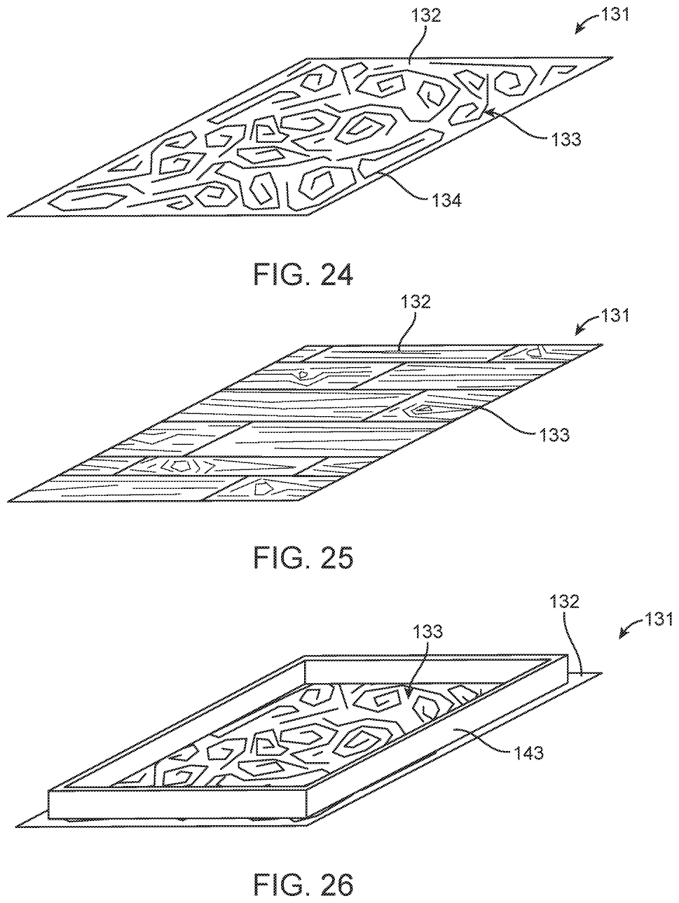

An optional embodiment of the method for creating a reproduction with a three-dimensional surface of artwork having an image is as follows, and shown for example in FIGS. 24-37. In an optional step, a mold formed from an air permeable material of the three-dimensional surface is provided. The mold can be a positive mold, a negative mold or any other type of mold. The mold can be of any suitable construction.

In an optional step, the air permeable mold is formed from a material, for example a flowable compound that when cured is air permeable. In an optional embodiment of forming the mold from a flowable compound, a surface having a positive or negative representation of the three-dimensional surface desired for the reproduction is provided (see FIGS. 24-25). A substrate or sheet 131 having a desired three dimensional surface 132 can optionally be provided. The substrate or sheet 131 can optionally be an original painting or other piece of art having an image with a three-dimensional surface, for example of canvas texture, brush strokes, pallet applications, squeeze bottle applications or any combination of the foregoing. The substrate can optionally be flexible or rigid and be made from any suitable material, including for example canvas, cotton, cotton canvas, textile, linen textile, burlap, burlap textile, wood, plastic, metal or any combination of the foregoing. The three-dimensional surface 132 can optionally be provided with any suitable texture 133, for example as shown in FIGS. 24-25. The texture 133 can optionally be any suitable art embellishments 134, for example art embellishments resembling brush strokes, pallet strokes or application, or both. Substrate 131 shown in FIG. 24 has a three-dimensional surface 132 with a texture 133 or art embellishments 134 resembling brush strokes. Texture 133 can optionally resemble a woven textile, a knit textile, a crocheted textile, a nonwoven textile, felt, wool, silk, acrylic, cotton, polyester, rayon, nylon, leather, canvas, artist's canvas, wood, metal, plastic, or any combination of the foregoing. In FIG. 25, texture 133 on three-dimensional surface 132 resembles wood. Substrate 131 shown in FIG. 25 can optionally be a sheet or piece of wood having a three-dimensional surface 132 with a texture 133 of wood.

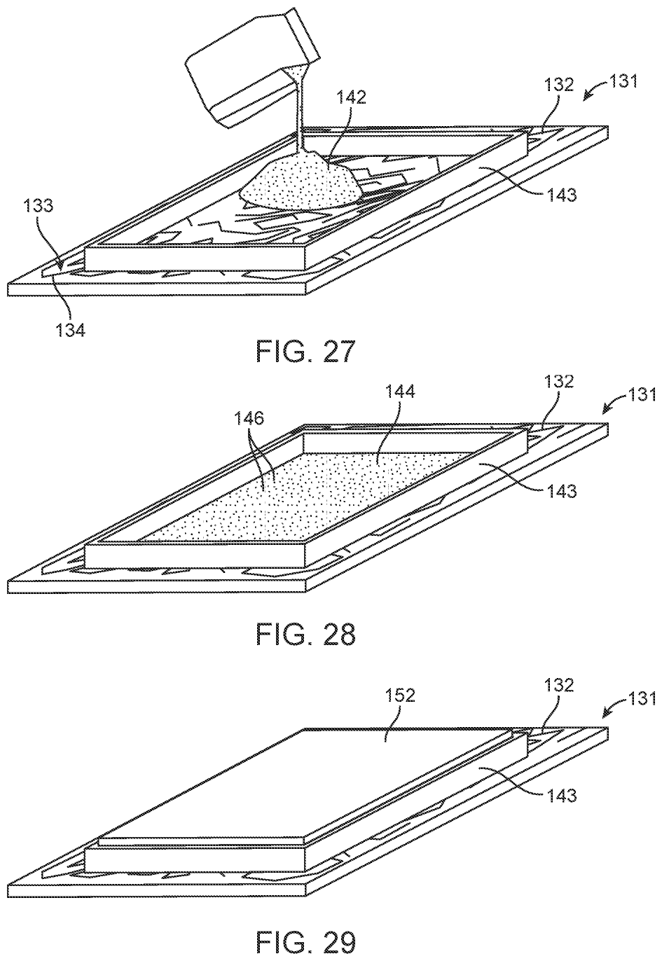

In an optional step of forming the mold 141, a material 142, for example a flowable compound of any suitable type, is disposed on the three-dimensional surface 132 of substrate 131 in any suitable manner. The material or compound is optionally air permeable. The material or compound can optionally be a flowable mixture or compound of granular particles and a binder that when cured or hardened forms an air permeable solid from the mixture. The binder optionally serves to bind, secure or adhere the granular particles together in a manner that results in flow passageways between the adjoined particles. For example, the binder optionally does not bind or adhere to all surfaces of a particle but instead only to some or a portion of the surfaces of a particle. The binder optionally coats the particles when the mixture or compound is in a flowable state, that is before it is cured or hardened. When cured or hardened, the coating optionally softens, coalesces and binds the granular particles at only select locations to form an air permeable solid. The granular particles can optionally be a sand. The binder or epoxy can optionally be a powder, a liquid or both. The mixture can optionally include a catalyst. The material can optionally be cast over and optionally around the original article to be replicated, for example over three-dimensional surface 132. In FIG. 27, for example, the flowable compound 142 or material is poured onto surface 132. The substrate 131 can optionally be supported in any suitable manner, for example to support the weight of material 142, any processing of the material 142 or both.

In an optional step of forming mold 141, a form 143 of any suitable type is provided, for example on three-dimensional surface 132, for providing a desired size and shape to the mold (see FIG. 31). Form 143 optionally constrains flowable compound 142 on the portion of surface 132 desired to be replicated.

In an optional step, the flowable compound or material 142 forms an air permeable layer 144 over the three-dimensional surface 132, for example within form 143 (see FIG. 28). The air permeable layer 144 can inherently be provided with passageways or channels 146 through it, shown schematically in FIG. 28, for example air passageways or channels.

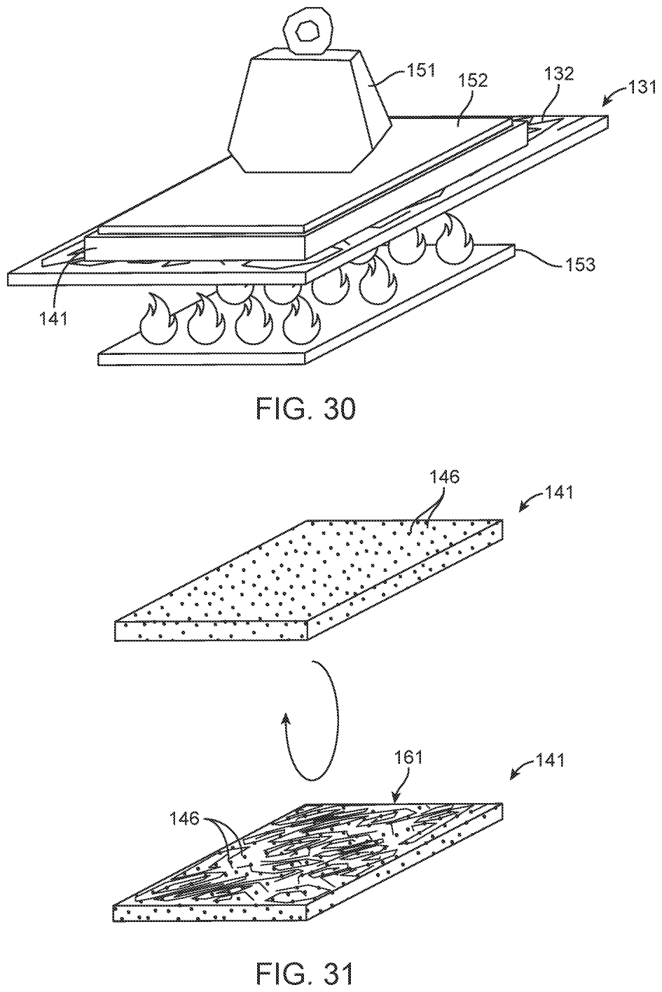

In an optional step, layer 144 of the flowable compound or material 142 is hardened, for example cured, in any suitable manner to form air permeable mold 141. Pressure can be applied to the layer 144, heat can be provided to the layer 144 or both as part of an optional hardening or curing step (see FIGS. 29-30). For example, when heated and placed under pressure, material 142 can flow around a three-dimensional surface 132 until it reaches sufficient temperature to cure. Once cured, for example, the material 144 can optionally become a solid mold 142 with micro channels 146 through it. For example, when material is a suitable powder or epoxy and granular particles, the individual particles arrange so that micro channels 146 are present throughout the solid mold 142. The channels 146 optionally enable a high degree of air flow in all directions through the solid mold so that the mold 142 can optionally function as a vacuum forming mold, for example with high fluid permeability. Optionally, no additional holes need be created in mold 142, for example drilled or otherwise formed, for the mold to function as a suitable vacuum forming mold in the methods of the invention. The application of pressure to layer 144 is shown schematically in FIGS. 29-30 by weight 151 and pressure distribution plate 152. The application of heat to layer 144 is shown schematically in FIG. 30 by heater 153, which can be of any suitable type, for example any heater suitable for curing purposes.

Mold 141 can optionally be formed with artistic embellishments, for example similar to artistic embellishments 72, three-dimensional surface reliefs, for example similar to three-dimensional surface reliefs 112, or any other surface feature for being produced in a vacuum forming process. Such surface features can optionally be shallow, for example having a surface with height differentials between peaks and troughs of not greater than 0.25 inch. Relatively small height differentials between peaks and troughs of the surface features can facilitate the advantages discussed above during the vacuum forming process.

In an optional step, mold 141 is removed or disengaged from three-dimensional surface 132, and optionally form 141. Mold 141 optionally has a size, shape and sufficient rigidity for use as a mold in a vacuum forming process. Mold 141, as shown in FIG. 31, has a three-dimensional mold surface 161 that is a negative of three-dimensional surface 132 of substrate 131.

In an optional alternative step of forming the air permeable mold 141 (not shown), a blank mold is formed in any suitable manner with an upper surface that does not include some or all of the desired three-dimensional surface features, as in three-dimensional mold surface 161, but is instead smooth, relatively smooth or capable of having some or all of the desired three-dimensional surface features formed on the upper surface. The blank mold, which can be referred to as an air permeable blank or air permeable blank mold, can be formed in any suitable manner, for example similar to the method of forming mold 141. The substrate 131 for use with form 143 for forming the blank mold can optionally have a smooth surface on to which flowable compound 142 is poured for forming the upper surface of the blank mold. Such upper surface can be referred to as a blank surface or blank upper surface. After solidification of the flowable compound, the blank surface can be engraved, machined or otherwise processed or worked on in any suitable manner to create or complete a desired three-dimensional mold surface 161 and air permeable mold 141.

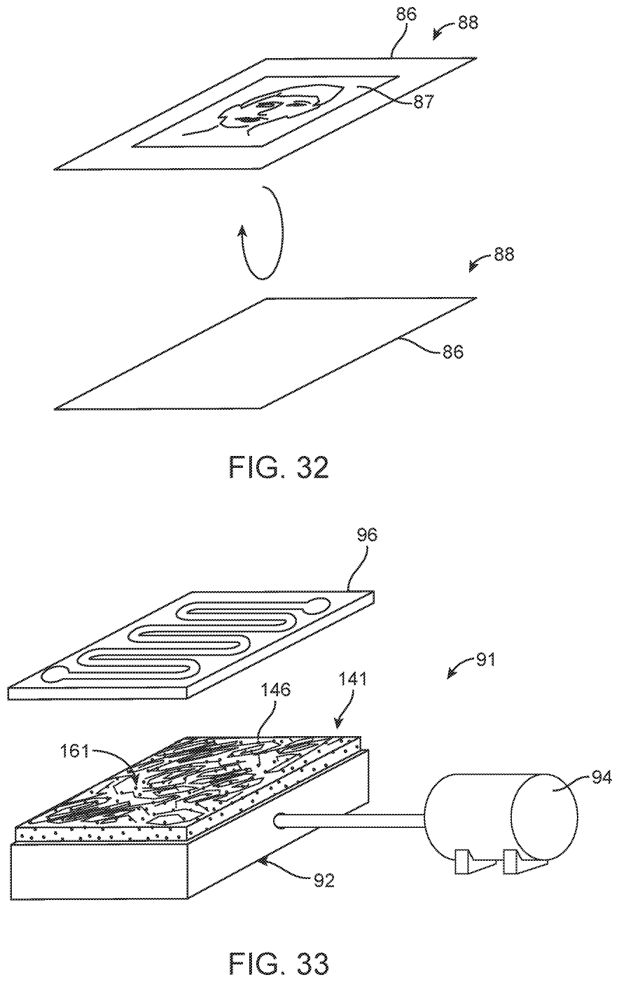

In an optional step, a substrate of any suitable type. for example substrate 86 discussed above, can be provided (see FIG. 32). In an optional step, an image 87 is formed on the substrate 86 in any suitable manner to form a printed substrate 88, for example as discussed above.

In an optional step, any suitable vacuum system, for example vacuum system 91 discussed above, can be provided (see FIGS. 33-36). The vacuum system 91 can optionally include a vacuum table 92, having a vacuum surface 93, coupled to a pneumatic pump 94 of any suitable type for providing negative pressure or vacuum to surface 93. In an optional step, any suitable heater or heating element, for example heater or heating element 96 discussed above, can be provided (see FIGS. 33-36). The heater 96 can be of any suitable type, for example any conventional heater or heater suitable for use with a vacuum table 92.

In an optional step, mold 141 is positioned on vacuum table 92, optionally overlying vacuum surface 93 of vacuum table 92 to that suction or negative pressure from the vacuum table can draw air through the mold (see FIG. 33). The three-dimensional mold surface 161 of the mold 141 is disposed upwardly or away from the vacuum table 92.

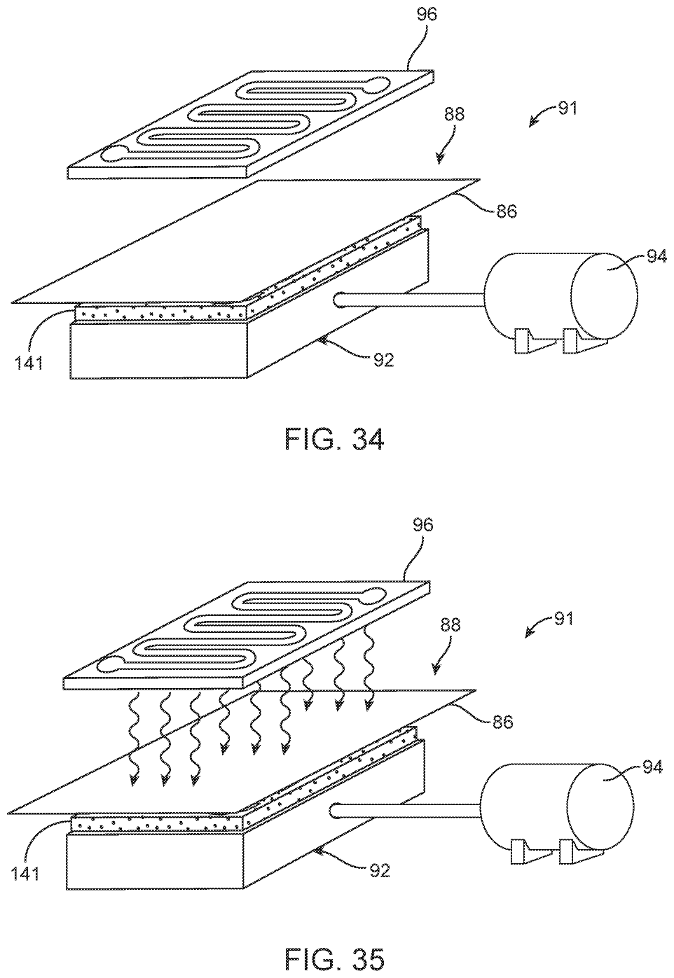

In an optional step, printed substrate 88 is positioned over mold 141 (see FIG. 34). The printed substrate 88 is optionally aligned with the mold 141, the vacuum surface 93 or both so that the three-dimensional mold surface 161 is desirably or properly aligned or registered with the desired locations on the printed substrate. The printed substrate 88 can optionally be placed directly on the mold 141. The printed substrate 88 can optionally be positioned close to but above the mold. Image 87 provided on the printed substrate 88, and the surface of the substrate 88 on which the image is formed, can optionally face the mold 141 and vacuum surface 93 of the vacuum table, as shown in FIG. 34. For example, the mold 141 can serve as a negative mold. It is appreciated that image 87 provided on the printed substrate 88, and the surface of the substrate 88 on which the image is formed, can optionally face away from the mold 141 and vacuum surface 93 of the vacuum table (not shown). For example, the mold 141 can be configured to serve as a positive mold.

In an optional step, the perimeter of the printed substrate 88 can be clamped to the vacuum system 91 (not shown), for example to the vacuum table 92, so that the printed substrate is held in place, for example relative to the mold 141, the vacuum table 92 or both. The printed substrate 88 can optionally not be clamped to the vacuum system 91, for example when the shrinking, movement or both of the printed substrate 88 results in an acceptable finished product.

In an optional step, the printed substrate 88 is heated, for example to a desired temperature, to permit deformation of the substrate 88, for example in a thermoforming step (see FIG. 35). The printed substrate can be heated in any suitable manner, for example by a suitable heater appropriately positioned relative to the printed substrate 88. Heater 96, overlying the printed substrate and the embellished sheet 73, can optionally be used to provide heat to the printed substrate 88.

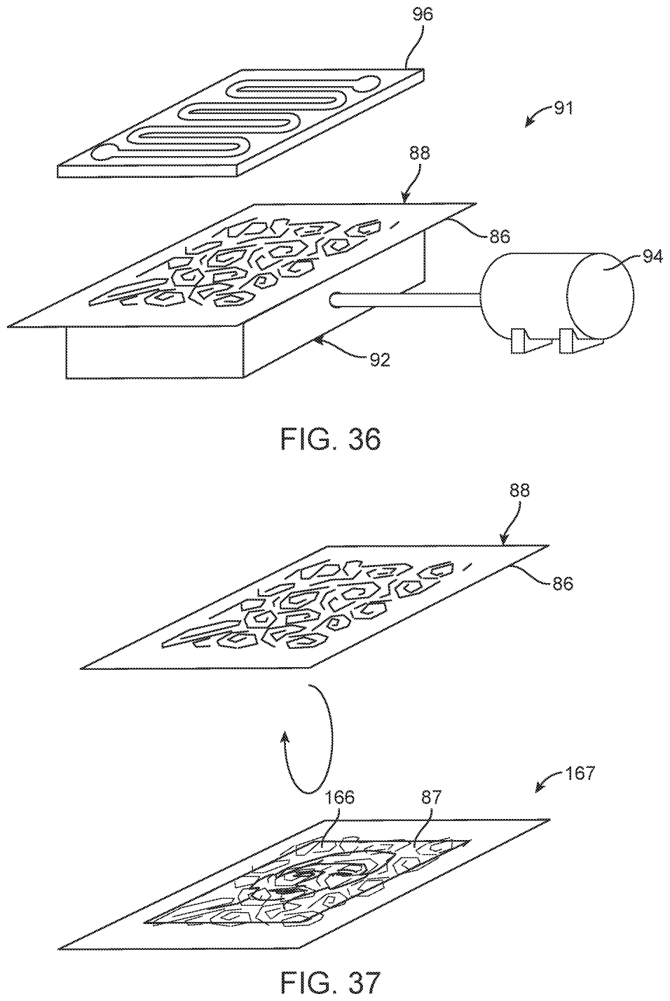

In an optional step, sufficient vacuum or negative pressure is provided to vacuum table 92, for example from pump 94, to press or to draw printed substrate 88 on to mold 141 to cause the three-dimensional mold surface 151 of the mold to deform the printed substrate, for example in a thermoforming process or step (see FIG. 36). The deformation of the printed substrate 88 by the mold 141 optionally reproduces the three-dimensional surface 132 of the substrate 131, including any texture 133 and art embellishments 134 on the substrate 131, on to the printed substrate 88, for example into the image 87 formed on the printed substrate 88. The three-dimensional surface reproduced on the printed substrate, including on image 87 of the substrate 88, can be referred to as a reproduced three-dimensional surface 166 (see FIG. 37).

In an optional step, the printed substrate 88 with the reproduced three-dimensional surface 166, which can optionally be referred to as a reproduced image 167, is optionally removed from the mold 141 and the vacuum table 92. In an optional step, the reproduced image 167 can be mounted on any desirable support structure to provide an image display (not shown).

The foregoing method can advantageously create reproductions of original paintings, and other three-dimensional surface detailed graphic images, that are indistinguishable from the original and at costs that can meet marketplace price constraints. The method can optionally provide texture or embellishments to reproductions of two-dimensional artwork or images. In addition, the invention can provide for mass production that is currently unavailable for hand-made artwork or articles. The optional use of ultra-thin films for substrate 86 can enable the thermoformed texture, embellishments or both to be visible through the front of the printed substrate 88, for example in the case of a positive mold, and can optionally enable the printed side of the substrate 88 to be positioned away from the mold 141. This can be particularly important where mold 141 is a negative mold as a typical problem of thermoforming preprinted materials is that the ink often can stick to the mold making removal of the formed substrate from the mold difficult.

I claim:

1. A vacuuming forming method for creating an embellished reproduction of an image, comprising printing the image on to a thermoformable substrate to create a printed substrate, providing a perforated sheet having a surface, applying a chemical compound to the surface of the perforated sheet to form artistic embellishments on the surface and create an embellished sheet, positioning the embellished sheet on a vacuum table, positioning the printed substrate over the embellished sheet, heating the printed substrate and providing sufficient vacuum to the vacuum table to press the printed substrate on to the embellished sheet to form an embellished reproduction of the image from the printed substrate and removing the embellished reproduction from the embellished sheet.

2. The method of claim 1, wherein the perforated sheet is an air permeable textile.

3. The method of claim 1, wherein the perforated sheet has a surface with a texture, wherein the embellished sheet includes the texture of the perforated sheet and wherein the embellished reproduction includes the texture of the perforated sheet.

4. The method of claim 3, wherein the texture is selected from the group consisting of a woven textile, a knit textile, a crocheted textile, a nonwoven textile, felt, wool, silk, acrylic, cotton, polyester, rayon, nylon, leather, canvas, artist's canvas, wood, metal plates, plastic and any combination of the foregoing.

5. The method of claim 2, wherein the air permeable textile is selected from the group consisting of a flexible material made by creating an interlocking bundle of fibers, yarns or threads, a material made from man-made or natural fibers, a woven textile, a knit textile, a crocheted textile, a nonwoven textile, felt, wool, silk, acrylic, cotton, polyester, rayon, nylon, leather, canvas, artist's canvas and any combination of the foregoing.

6. The method of claim 1, wherein the perforated sheet is selected from the group consisting of perforated aluminum and perforated wood.

7. The method of claim 1, wherein the applying step includes applying with a tool selected from the group consisting of a brush, a pallet knife, a squeeze bottle any tool that can apply paint, any tool that can apply a chemical and any combination of the foregoing.

8. The method of claim 1, wherein the chemical compound is selected from the group consisting of paint, acrylic paint, silicone paint, an acrylic polymer, silicone, a moldable material, a curable compound, a heat-curable compound and any combination of the foregoing.

9. The method of claim 1, wherein the thermoformable substrate is made from polyvinyl chloride.

10. The method of claim 1, wherein the thermoformable substrate has a thickness selected from the group consisting of 0.003 inch and ranging from 0.002 to 0.020 inch.

11. The method of claim 1, wherein the step of positioning the printed substrate over the embellished sheeting includes positioning the printed substrate over the embellished sheet with the image of the printed substrate facing away from the embellished sheet.

12. The method of claim 1, wherein the art embellishments are three-dimensional art embellishments.

13. The method of claim 1, wherein the printing step includes printing selected from the group consisting of digital printing, digital inkjet printing, offset printing and flexographic printing.

14. The method of claim 1, wherein the positioning the printed substrate over the embellished sheet step includes laying the printed substrate directly on the embellished sheet.

15. A vacuuming forming method for producing an image with a texture, comprising printing the image on to a thermoformable substrate to create a printed substrate, providing a flexible air permeable material having the texture as a mold, positioning the flexible air permeable material on a vacuum table, positioning the printed substrate over the flexible air permeable material, heating the printed substrate and providing sufficient vacuum to the vacuum table to press the printed substrate on to the flexible air permeable material to form from the texture in the printed substrate and removing the printed substrate from the flexible air permeable material.

16. The method of claim 15, wherein the flexible air permeable material has three-dimensional surface reliefs to form the texture of the flexible air permeable material.

17. The method of claim 15, wherein the flexible air permeable material has a surface with height differentials between peaks and troughs of not greater than 0.25 inch.

18. The method of claim 15, wherein the flexible air permeable material is approximately flat.

19. The method of claim 15, wherein the flexible air permeable layer material is a textile.

20. The method of claim 15, wherein the step of positioning the printed substrate over the flexible air permeable material includes positioning the printed substrate over the flexible air permeable material with the image of the printed substrate facing the flexible air permeable material.

21. A vacuuming forming method for creating a reproduction with a three-dimensional surface of artwork having an image, comprising printing the image on to a thermoformable substrate to create a printed substrate, providing a mold formed from a flowable compound of a binder and granular particles that when cured is an air permeable material and has a three-dimensional mold surface, positioning the mold on a vacuum table, positioning the printed substrate over the mold, heating the printed substrate and providing sufficient vacuum to the vacuum table to press the printed substrate on to the three-dimensional mold surface of the mold to form a reproduction of the artwork with the three-dimensional surface from the printed substrate and removing the reproduction from the mold.

22. The method of claim 21, wherein the providing step includes engraving the three-dimensional mold surface into a solid formed from the air permeable material.

23. The method of claim 21 wherein the mold is selected from the group consisting of a positive mold and a negative mold.

24. The method of claim 21, wherein the three-dimensional surface has a texture.
